(19) United States
(12) Patent Application Publication
(10) Pub. No.: US 2007/0033100 A1
(43) Pub. Date: Feb. 8, 2007

(54) Method and apparatus for administering maintenance and loyalty programs

(75) Inventor: Richard L. Knight, Massillon, OH (US)

Correspondence Address: SAND & SEBOLT, AEGIS TOWER, SUITE 1100, 4940 MUNSON STREET, NW, CANTON, OH, 44718-3615, US

(73) Assignee: PERFORMANCE ADMINISTRATION CORP., Canton, OH (US)

(21) Appl. No.: 11/197,901

(22) Filed: Aug. 5, 2005

(51) Int. Cl. G06Q 30/00

(52) U.S. Cl. 705/14

(57) ABSTRACT

A method of administering a maintenance, loyalty and gift value program includes the steps of storing in a central database customer value-availability information for each of a plurality of customers to include availability of coupon or maintenance value, loyalty value and gift value. A wireless handheld portable terminal scans a machine-readable tag or a product identifier is entered into the portable terminal to ascertain a given customer's customer identifier. The portable terminal accesses the database to retrieve the information for the given customer via the customer identifier. The customer approves redemption of a value whereupon the availability of the value is deleted from the database and the value is rendered to the customer. Where a group of business entities are associated with one another, values which are associated with one of the business entities may be redeemed at another of the business entities.

### BACKGROUND OF THE INVENTION

1. Technical Field

The invention relates generally to a method and apparatus for administering maintenance, loyalty and gift card programs. More particularly, the invention relates to administering all three of these programs via a centralized database. Specifically, the invention relates to such a method in which a wireless portable terminal is used to identify customers and access a centralized database to track and control availability of maintenance, loyalty and gift benefits.

2. Background Information

The use of maintenance, loyalty and gift card programs are well known and useful for attracting business and encouraging loyalty to a particular business. Although used in various settings, the use of each of these programs is well suited to car dealerships. Many car dealerships will create a customized maintenance program associated with a particular customer and typically with regard to a particular motor vehicle. A customer will typically pay for a package deal for maintenance in which certain maintenance services are to be performed at various times. In effect, these various services are used like coupons which provide a specified value which must be taken advantage of during a certain window before that particular coupon expires. Although a customer will typically pay for a maintenance/service program, coupons for various values may also be used which were not paid for by the customer.

As is well known, loyalty programs involve a customer acquiring loyalty points related to the amount of money spent at a particular business entity. Once the customer has accrued a sufficient number of loyalty points, the customer can then redeem some or all of the loyalty points for one or more reward options.

The use of gift programs such as gift cards allows a customer or another individual to purchase gift credits which can then be utilized by the customer for purchasing service or products from the business entity. Thus, gift cards function essentially the same as cash except that the value must be used at a given business.

Each of these types of programs has been administered individually in the past. This presents several problems. First, when a business entity wishes to utilize each of the programs, it requires the use of three separate systems corresponding to each of the programs. In addition, it also requires the use of the associated apparatus for administering the program. For instance, gift credits are typically recorded on a magnetic strip of a gift card, which is then read by an electronic device which is hardwired to a computer system. The maintenance and loyalty programs may use similar devices or another method for administration thereof. Regardless of the particular apparatus and method used for each program, there remains a need for a centralized program for administering all three of these programs simultaneously and with apparatus which eliminates duplication and minimizes the space taken up by the apparatus needed for administering the programs separately.

In addition, the use of cards with magnetic strips on which the maintenance, loyalty or gift credits are recorded has been shown to be problematic when the magnetically recorded information is inadvertently erased by exposure to a magnetic field or by physical damage to the magnetic strip. Further, the data-reading machinery used for these various systems typically is mounted inside of a building and hardwired as well so that either due to size, mounting or hardwiring thereof, the apparatus is not portable. Thus, the reading of the value data is limited to a particular location. In certain businesses such as car dealerships, it would be helpful to have a portable scanner and/or data entry device so that information from an automobile or other product may be scanned or entered into a portable device at one location, such as the location of the car outside of a building, so that information which is connected to the car or other product may be easily captured by the portable device and then used in the administration of all three programs. The present invention addresses these various issues.

### BRIEF SUMMARY OF THE INVENTION

The present invention provides a method comprising the steps of assigning to a first customer a first customer identifier; storing in a central database customer value-availability information associated with a plurality of customers wherein the information associated with each customer includes availability of coupon value, loyalty value and gift value; accessing the information associated with the first customer via the first customer identifier; deleting from the database availability of a claimed value the redemption of which has been approved by the customer wherein the value includes at least one of coupon value, loyalty value and gift value; and rendering the claimed value to the customer.

### BRIEF DESCRIPTION OF THE SEVERAL VIEWS OF THE DRAWINGS

Preferred embodiments of the invention, illustrative of the best modes in which applicant contemplates applying the principles, are set forth in the following description and are shown in the drawings and are particularly and distinctly pointed out and set forth in the appended claims.

FIG. 1 is a diagrammatic view of the apparatus of the present invention and shows a machine-readable tag, a pair of portable terminals with corresponding base units and a central database in which value availability information is stored.

FIG. 2 is a diagrammatic view of a vehicle having a vehicle identification number and a machine-readable tag attached to the vehicle.

FIG. 3 is flow chart showing the overall process of the present invention, including the maintenance program portion thereof.

FIG. 4 is a flow chart associated with the loyalty program portion of the process of the present invention.

FIG. 5 is a flow chart showing the gift credit portion of the process of the present invention.

Similar numbers refer to similar parts throughout the specification.

### DETAILED DESCRIPTION OF THE INVENTION

The apparatus used for administering maintenance, loyalty and gift programs of the present invention is indicated generally at 10 in FIG. 1. Apparatus 10 includes a machine readable tag 12 having a bar code 14 thereon, a first reading device in the form of a handheld wireless portable terminal (PT) 16, a first base unit or cradle 18 which includes a modem, and a central database 20. Optionally, apparatus 10 may include a second portable terminal 22 and a second base unit or cradle 24 having configurations which are respectively the same as first PT 16 and first cradle 18.

First PT 16 includes a scanner 26, which doubles as a display screen. PT 16 further includes a data entry pad in the form of a key pad 28 as well as various control keys 30. First PT 16 is associated with first cradle 18 and may be placed therein as indicated by Arrow A so that first PT 16 is in communication with first cradle 18. First cradle 18 is in communication with central database 20 whereby first PT 16 is selectively in communication with central database 20 when seated in first cradle 18 via the modem thereof. First PT 16 and first cradle 18 are associated with and located at a first business entity such as a motor vehicle dealership 32. As previously noted, second PT 22 and second cradle 24 are configured respectively like PT 16 and cradle 18. However, second PT 22 and second cradle 24 are associated with and located at a second business entity such as a second motor vehicle dealership 34. Scanner 26 of first PT 16 is configured to read or scan bar code 14 of tag 12 as indicated by the dashed line therebetween and second PT 22 has the same capability.

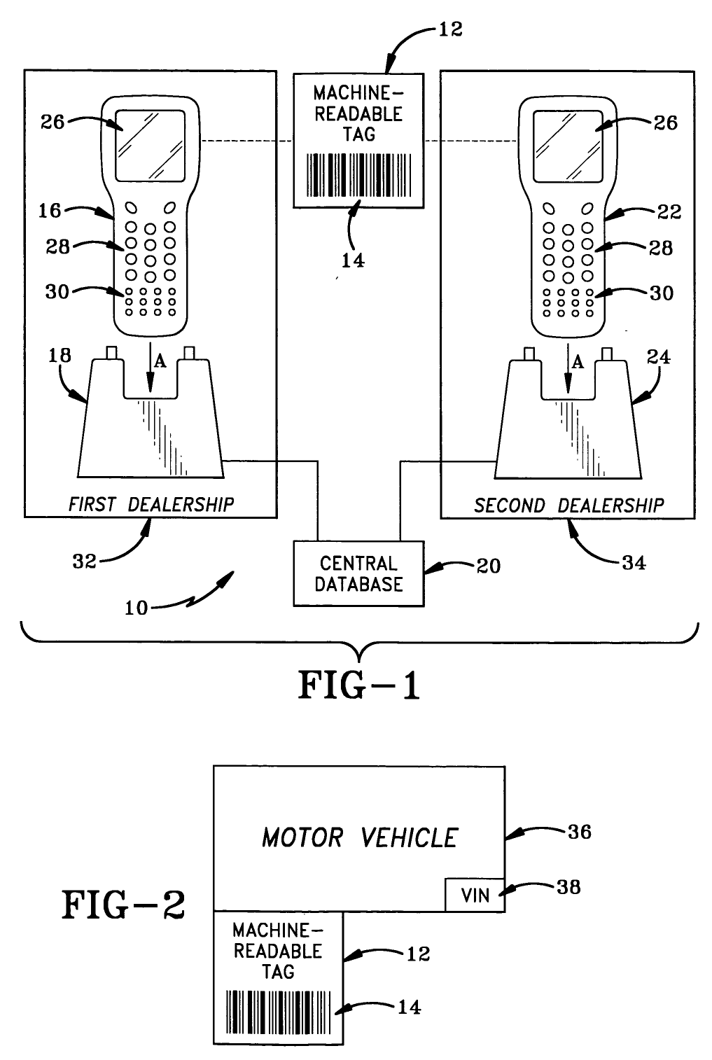

Tag 12 may be in the form of a card or other durable structure so that it may be carried by a customer and may be in the form of a key tag or the like. Tag 12 may also be, for instance, a flexible sticker with an adhesive thereon whereby tag 12 is mountable as desired. With reference to FIG. 2, tag 12 may be mounted on a product such as a motor vehicle 36 by an adhesive or other suitable means known in the art. Vehicle 36 or other products may include a product identifier such as a vehicle identification number (VIN) 38 or a portion thereof. Thus, PT 16 or PT 22 may be used to scan or read tag 12 in order to access a customer identifier, which may be a contract number related to a contract which a customer has entered into with dealership 32 or 34 regarding a maintenance, loyalty and gift program. Due to the handheld wireless nature of PT 16, tag 12 may be read while it is adhered to a product such as motor vehicle 36. As noted, this allows this information to be accessed at the vehicle itself. In addition, VIN 38 or a portion thereof may be entered into PT 16 via key pad 28 in order to identify vehicle 36 and also the customer who owns vehicle 36. Thus, the product identifier or VIN 38 is associated with the customer identifier, which as noted above may be a contract number.

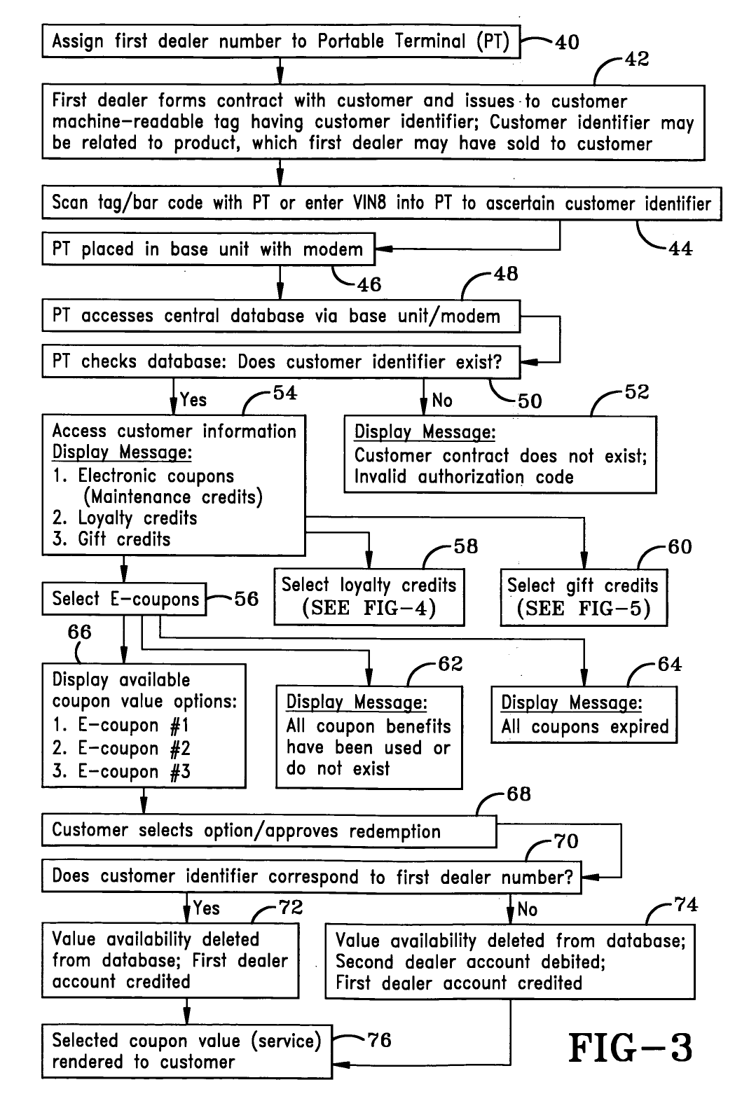

The method of the present invention is more particularly described with reference to FIGS. 3-5. With reference to FIG. 3, a first dealer number or identifier is assigned to PT 16, as indicated at 40. In setting up the maintenance, loyalty and gift program with a customer, first dealership 32 (FIG. 1) typically forms a contract with the customer and issues to the customer tag 12 which has the customer identifier associated with that customer, as indicated at 42. As previously noted, the customer identifier may be related to a product such as motor vehicle 36 which first dealership 32 may have sold to the customer originally, also indicated at 42. Thus, the customer identifier is associated with tag 12, the customer, first dealership 32 and to a product such as vehicle 36 if this is part of the program. Value availability associated with the customer will be entered into central database 20 (FIG. 1) to include information showing the availability of electronic coupons or maintenance credits, loyalty credits and gift credits.

Once this program has been set up, when the customer comes to dealership 32, an employee of dealership 32 will scan bar code 14 of tag 12 with first PT 16 to ascertain the customer identifier or ultimately enter the VIN 38, which is shown as VIN8 in block 42, meaning that, for example, the last eight (8) digits of the VIN may be used. Once PT 16 has captured the customer identifier, PT 16 is then placed in the base unit or cradle 18, as at 46, and then dials up to access the central database 20 via the base unit and modem thereof, as indicated at 48. As noted at 50, the PT then determines whether a customer identifier for the given customer exists. If not, display screen 26 will display a message indicating that the customer contract does not exist and/or that there is an invalid authorization code, as at 52.

If the customer identifier does exist, PT 16 will access the customer information and display options which may be selected, more particularly maintenance credits which are in the form of electronic coupons (E-coupons), loyalty credits and gift credits, as indicated at 54. Once these options are displayed, one of them is then selected, as indicated at 56, 58 and 60. The process with regard to loyalty credits and gift credits will be discussed further below. When E-coupons or maintenance credits are selected as at 56, PT 16 then determines the availability of E-coupon value or maintenance value for the customer. If all the E-coupon or maintenance benefits have been used or do not exist, a display message to that effect will show on screen 26, as indicated at 62. Alternately, all the coupons may have expired in which case a message to that effect will be displayed as at 64. If maintenance value is still available, that will be displayed as at 66 to show the various coupon options. Once the options are displayed, the customer will select an option and approve redemption thereof, as indicated at 68.

In certain cases, there may be more than one business entity or dealership such as dealerships 32 and 34, which are part of an associated group which is typically owned by a common owner. As a result, apparatus 10 may be set up to incorporate a plurality of dealerships so that the method includes the ability to transfer the customer's available value between dealerships. Thus, where first dealership 32 may have formed a contract with a customer to include a maintenance, loyalty and gift program, the second dealership may ultimately provide service and the like to the customer even though they were not the issuing dealership. With this in mind, PT 16 determines whether the customer identifier corresponds to the first dealer number or another dealer number, as indicated at 70.

If the customer identifier does correspond to the first dealer number, the value availability of the E-coupon or maintenance value is deleted from the central database and an account of the first dealer is credited an amount associated with the value, as indicated at 72. If the customer identifier does not correspond to the first dealer number and instead corresponds to a second dealer number within the group, the value availability is deleted from the central database, an account of the second dealer is debited the value and the account of the first dealer is credited the value, as indicated at 74. In either case, once the value availability is deleted from the database and the first dealer's account is credited, the coupon value or service is rendered to the customer as indicated at 76.

With reference to FIG. 4, the method is picked up at the selection of loyalty credits as at 58. At this point, PT 16 checks the database to determine if there are any available loyalty credits and displays respective messages as at 78 and 80 if the loyalty benefits have been used or do not exist, or all the availability credits have expired. If loyalty credits are available, this is displayed as at 82 and reward options are then displayed as at 84. The reward options displayed may include those that the customer has sufficient credits for as well as those that the customer does not have sufficient credits for. Where the customer has insufficient loyalty points to redeem a given reward option, the manager of dealership 32 has the option of overriding the program in order to allow the customer to obtain such a reward option. For a car dealership, the reward options could include dealer service, parts or sales rewards, discounts and the like. As shown at 86, the customer then selects one of the options and approves redemption thereof. As previously described with regard to the maintenance credits, PT 16 then determines whether the customer or the buyer corresponds to the first dealer number or not as indicated at 88. If so, the value availability is deleted from the database and the first dealer account is credited as indicated at 90. If not, and where the customer identifier corresponds to a second dealer number, the availability is deleted from the database, the second dealer account is debited and the first dealer account is credited as shown at 92. In either case, the selected reward value is rendered to the customer, as at 94.

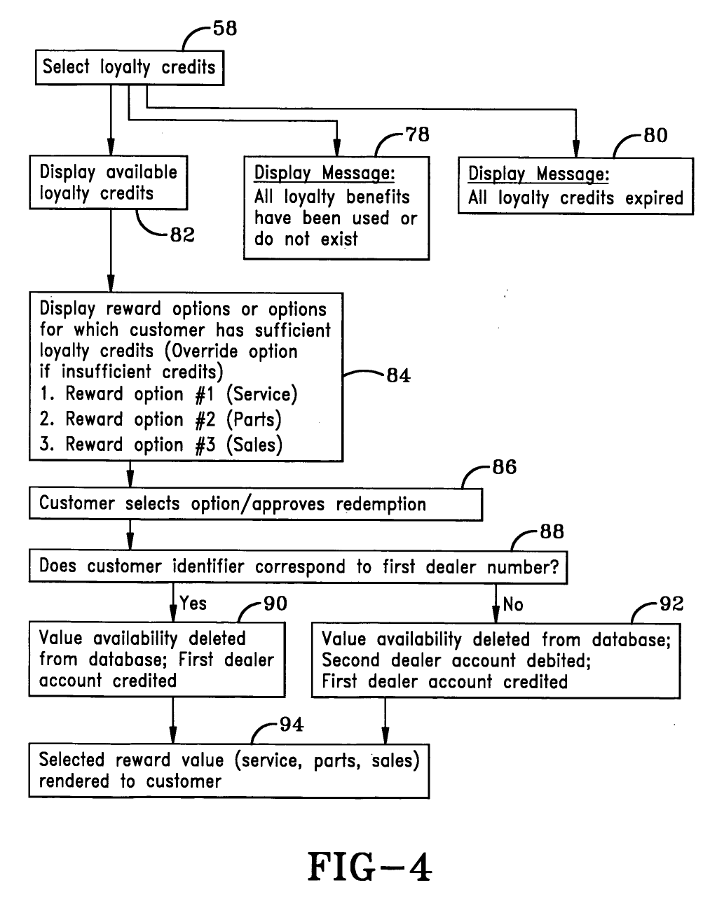

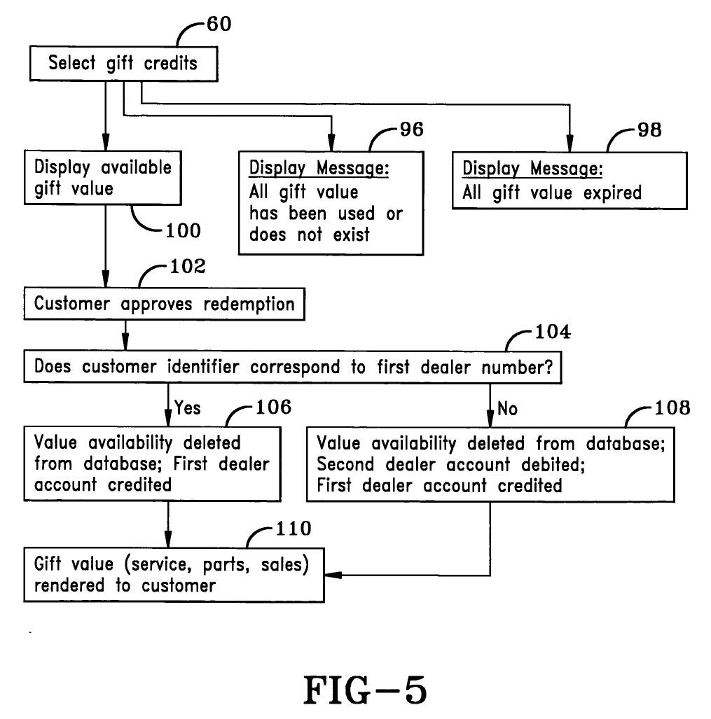

With reference to FIG. 5, the method is picked up at the selection of gift credits, as shown at 60. When gift credits are selected, PT 16 determines whether there are any credits available and then displays similar messages as with the maintenance and loyalty credits. Thus, the display message at 96 will appear on display screen 26 if all of the gift value has been used or does not exist and the message at 98 will be displayed if all of the gift value has expired. If the gift credits are available, this is displayed on screen 26 as indicated at 100. The customer then approves redemption as indicated at 102 and PT 16 will determine whether the customer identifier corresponds with the first dealer number as indicated at 104. If so, once again the value availability is deleted from the database and the first dealer account is credited as indicated at 106 and if not, the value availability is deleted from the database, the second dealer account is debited and the first dealer account is credited as indicated as indicated at 108. In either case, the gift value is rendered to the customer, as at 110.

Thus, the apparatus and method of the present invention provide for the administration of a maintenance, loyalty and gift credit program which is greatly simplified in contrast to the known systems available. The centralized database allows for the unified tracking and control of all three aspects of the program. In addition, benefits preferably include the issuance of a tag which utilizes a nonmagnetic code in order to eliminate problems associated therewith. Further, the invention utilizes a portable terminal which is handheld and wireless to make the system substantially more convenient and permit easy data entry especially for products such as motor vehicles which include identification numbers and to which the machine-readable tag may be adhered.

While the present invention has been described primarily with regard to motor vehicle or car dealerships, other types of businesses may also benefit from the use of the present invention. Some of these business entities may not perform maintenance on a customer's product, but may use coupons or the coupon concept. Thus for instance, a restaurant might have a program which includes loyalty points, gift cards and coupons for predetermined values such as a free item of food or a discount on a purchase at the restaurant. Thus, any business or group of associated business entities which utilizes loyalty, gift and coupon-type values may utilize the apparatus and method of the present invention. In addition, the use of the wireless handheld portable terminal such as PT 16 may be very useful in a variety of businesses other than motor vehicle dealerships.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method comprising the steps of:
assigning to a first customer a first customer identifier;
storing in a central database customer value-availability information associated with a plurality of customers wherein the information associated with each customer includes availability of coupon value, loyalty value and gift value;
accessing the information associated with the first customer via the first customer identifier;
deleting from the database availability of a claimed value the redemption of which has been approved by the customer wherein the value includes at least one of coupon value, loyalty value and gift value; and
rendering the claimed value to the customer.

2. The method of claim 1 further including the steps of providing the first customer with a machine-readable tag; and reading the tag with a reading device to ascertain the first customer identifier.

3. The method of claim 2 wherein the step of reading includes the step of reading the tag with a handheld reading device.

4. The method of claim 3 wherein the step of reading includes the step of reading the tag with a wireless handheld reading device.

5. The method of claim 4 further including the step of adhering the machine-readable tag to a product; and wherein the step of reading includes the step of reading the tag while adhered to the product.

6. The method of claim 5 wherein the step of adhering includes the step of adhering the tag to a motor vehicle; and wherein the step of reading includes the step of reading the tag while adhered to the motor vehicle.

7. The method of claim 4 wherein the step of accessing includes the step of accessing the database with the reading device via a modem of a reading-device base unit.

8. The method of claim 4 wherein the step of reading includes the step of reading a non-magnetic code of the tag.

9. The method of claim 8 wherein the step of reading includes the step of reading a bar code of the tag.

10. The method of claim 3 wherein the step of providing includes the step of providing the first customer with a machine-readable tag associated with a product; and wherein the step of reading includes the step of reading the tag to ascertain the first customer identifier which is associated with the product.

11. The method of claim 10 wherein the step of providing includes the step of providing the first customer with a machine-readable tag associated with a motor vehicle; and wherein the step of reading includes the step of reading the tag with a wireless handheld reading device to ascertain the first customer identifier which is associated with the motor vehicle.

12. The method of claim 2 wherein the step of providing includes the step of providing the customer with the tag at a first motor vehicle dealership; wherein the step of reading includes the step of reading the tag at a second motor vehicle dealership; and further including the steps of debiting the claimed value from an account of the first dealership; and crediting the claimed value to an account of the second dealership.

13. The method of claim 2 wherein the step of providing includes the step of providing the customer with the tag at a first motor vehicle dealership; wherein the step of reading includes the step of reading the tag at a second motor vehicle dealership; and wherein the step of rendering includes the step of rendering the claimed value at the second dealership.

14. The method of claim 1 wherein the step of storing includes storing value-availability information wherein the information associated with each customer includes availability of coupon value which is associated with maintenance of a product.

15. The method of claim 14 wherein the step of storing includes storing value-availability information wherein the information associated with each customer includes availability of coupon value which is associated with maintenance of a motor vehicle.

16. The method of claim 1 wherein the step of rendering includes the step of servicing a product.

17. The method of claim 16 wherein the step of rendering includes the step of servicing a motor vehicle.

18. The method of claim 1 associating the first customer identifier with a product concerning which the first customer has entered a maintenance contract with a servicing entity associated with the first customer identifier.

19. The method of claim 1 providing the first customer with a machine-readable tag; and performing one of the steps of reading the tag with a reading device to ascertain the first customer identifier and entering a product identifier into the reading device to ascertain the first customer identifier.

20. The method of claim 1 further including the step of maintaining the claimed value in an account of a first business entity within a group of associated business entities; wherein the step of rendering includes the step of rendering the claimed value at the expense of a second business entity within the group; and further including the steps of debiting the claimed value from the account of the first business entity; and crediting the claimed value to an account of the second business entity.
